(19) United States
(12) Patent Application Publication
(10) Pub. No.: US 2007/0206520 A1
(43) Pub. Date: Sep. 6, 2007

(54) Multi-tasking method and apparatus in mobile terminal with DMB module

(75) Inventors: Joon-Sang Baek, Seoul (KR); Jae-Joon Hwang, Seoul (KR); Byeong-Cheol Hwang, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/704,142

(22) Filed: Feb. 8, 2007

(30) Foreign Application Priority Data
Feb. 8, 2006 (KR) 2006-0012258

(51) Int. Cl. H04H 1/00

(52) U.S. Cl. 370/312

(57) ABSTRACT

Provided is a method and apparatus for processing an event generated during a recording of a DMB program in a DMB mobile terminal. The method includes recording an incoming DMB program when a DMB record mode is selected; determining if an event is generated during the recording of the DMB program; determining whether to execute the generated event; and when the execution of the generated event is selected, processing the generated event while recording the DMB program.

### PRIORITY

This application claims priority under 35 U.S.C. §119 to a Korean application filed in the Korean Intellectual Property Office on Feb. 8, 2006 and allocated Serial No. 2006-12258, the contents of which are incorporated herein by reference.

### BACKGROUND OF THE INVENTION

1. Field of the Invention

The present invention relates generally to a mobile terminal with a Digital Multimedia Broadcasting (DMB) module, and in particular, to a method and apparatus for processing an event generated during recording DMB program in a mobile terminal with a DMB module.

2. Description of the Related Art

With the development of digital multimedia technology, the use of digital multimedia information is increasing. Accordingly, mobile terminals that can receive DMB signals are being developed. Hereinafter, these mobile terminals are referred to as DMB mobile terminals.

Conventional DMB mobile terminals cannot use a telephone service while receiving a DBM service. That is, because the second generation. (2G) mobile communication network merely provides a single service to a single mobile terminal, the mobile terminal cannot perform a multi-tasking function to provide the reception of DMB programs and telephone service at the same time.

As described above, because the mobile terminal does not support the multi-tasking function, the reception of the DMB program has to be stopped when the user wants to use the telephone service.

To alleviate this drawback, a receiving unit for call process and a transmitting unit for receiving DMB program are separately provided in the DMB mobile terminals. Accordingly, the user can use the telephone service while viewing the DMB program.

Meanwhile, although the DMB mobile terminals can use the telephone service while viewing the DMB program, it does not support a multi-tasking of additional functions such as message reception and an alarm function during the recording of DMB programs. Thus, the corresponding functions can only be carried out after the recording is completed.

Therefore, there is a demand for a method for a multi-tasking supporting method that can enable message reception service, alarm service, call reception function service, and scheduled recording service during the recording of DMB programs.

### SUMMARY OF THE INVENTION

An object of the present invention is to solve at least the above problems and/or disadvantages and to provide at least the advantages below. Accordingly, an object of the present invention is to provide a method for supporting a multi-tasking function in a mobile terminal with a DMB module.

Another object of the present invention is to provide a method for processing an event generated during the recording of a DMB program in a mobile terminal with a DMB module.

According to one aspect of the present invention, a method for processing an event generated during a recording of a DMB program in a DMB mobile terminal includes recording an incoming DMB program when a DMB record mode is selected; determining if an event is generated during the recording of the DMB program; determining whether to execute the generated event; and when the execution of the generated event is selected, processing the generated event while recording the DMB program.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a typical mobile terminal according to the present invention;

FIG. 2 is a flowchart outlining a method for processing an event generated during the recording of a DMB program in a mobile terminal according to the present invention;

FIGS. 3A to 3D are diagrams showing screens of a mobile terminal when it displays a call reception event generated during the recording of a DMB program according to the present invention; and

FIGS. 4A to 4C are diagrams showing screens of a mobile terminal when it displays an alarm event generated during the recording of a DMB program according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Hereinafter, a method for processing an event generated during the recording of a DMB program in a mobile terminal with a DMB module will be described in detail. The term “event” is a service that can be generated during a DMB service. Examples of the event include call reception service, message sending/receiving service, alarm service, and morning call service.

The mobile terminal includes all terminals that can receive DMB signals. Examples of such mobile terminal include Cellular Phones, Personal Communication System (PCS) phones, Personal Data Assistants (PDAs), International Mobil Telecommunication-2000 (IMT-2000) terminals, and 4G Broadband System terminals. The following descriptions will be made with a general structure of the above terminals as reference.

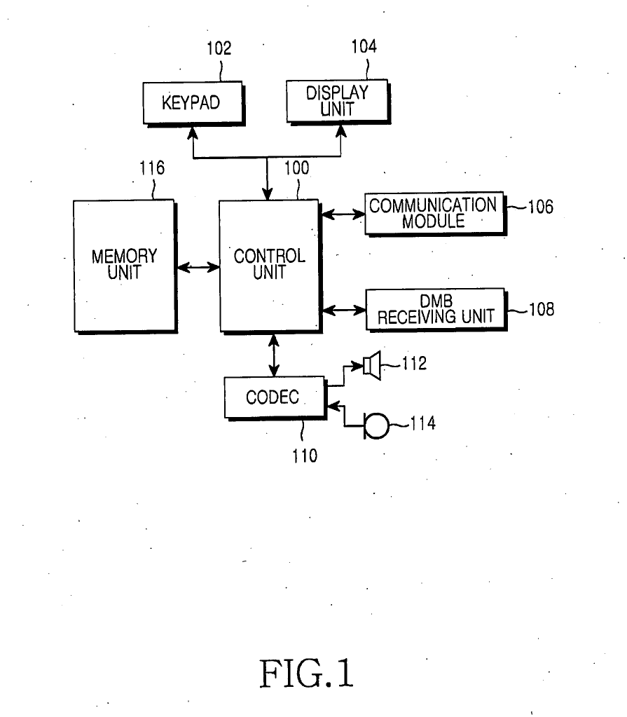

Referring to FIG. 1, the mobile terminal includes a control unit (e.g., a microprocessor unit (MPU)) 100, a keypad 102, a display unit 104, a communication module 106, a DMB receiving unit 108, a coder-decoder (CODEC) 110, a speaker 112, a microphone 114, and a memory unit 116.

Control unit 100 controls the overall operation of the mobile terminal. For example, control unit 100 processes and controls voice communication and data communication. In addition, when an event is generated during the recording of a DMB program, control unit 100 processes the generated event while recoding the DMB program. A detailed description about the general control operation of control unit 100 will be omitted for conciseness.

Memory unit 116 includes a read only memory (ROM) and a random access memory (RAM). The ROM stores a variety of reference data and microcodes of a program for the control and process of control unit 100. Under control of control unit 100, the incoming DMB program is recorded and stored in the ROM.

The RAM is a working memory of control unit 100 and temporarily stores data generated during the operations of programs.

The keypad 102 includes numeric keys of digits 0-9 and a plurality of function keys, such as a Menu key, a Cancel (Delete) key, a Confirmation key, a Talk key, an End key, an Internet connection key, and Navigation keys (or direction keys). The keypad 102 provides the control unit 100 with a key input data corresponding to a key pressed by a user.

Display unit 104 displays status information generated during operations of the mobile terminal, numerals and characters, moving pictures and still pictures, messages, and so on. A color Liquid Crystal Display (LCD) may be used as display unit 104.

DMB receiving unit 108 receives DMB signals.

CODEC 110 converts Pulse Code Modulation (PCM) data received from control unit 100 into an analog audio signal to output the analog audio signal through speaker 112, and converts an audio signal received through microphone 114 into PCM data to provide the PCM data to control unit 100.

Communication unit 106 includes a Radio Frequency (RF) module and a baseband processor. The RF module down-converts an RF signal received through the antenna (not shown) to provide the down-converted signal to the baseband processor, and up-converts a baseband signal received from the baseband processor to transmit the up-converted signal through the antenna. The baseband processor processes a baseband signal transmitted/received between the RF module and control unit 100. For example, during the transmission operation, the baseband processor channel-codes and spreads data to be transmitted. During the reception operation, the baseband processor despreads and channel-decodes the received data.

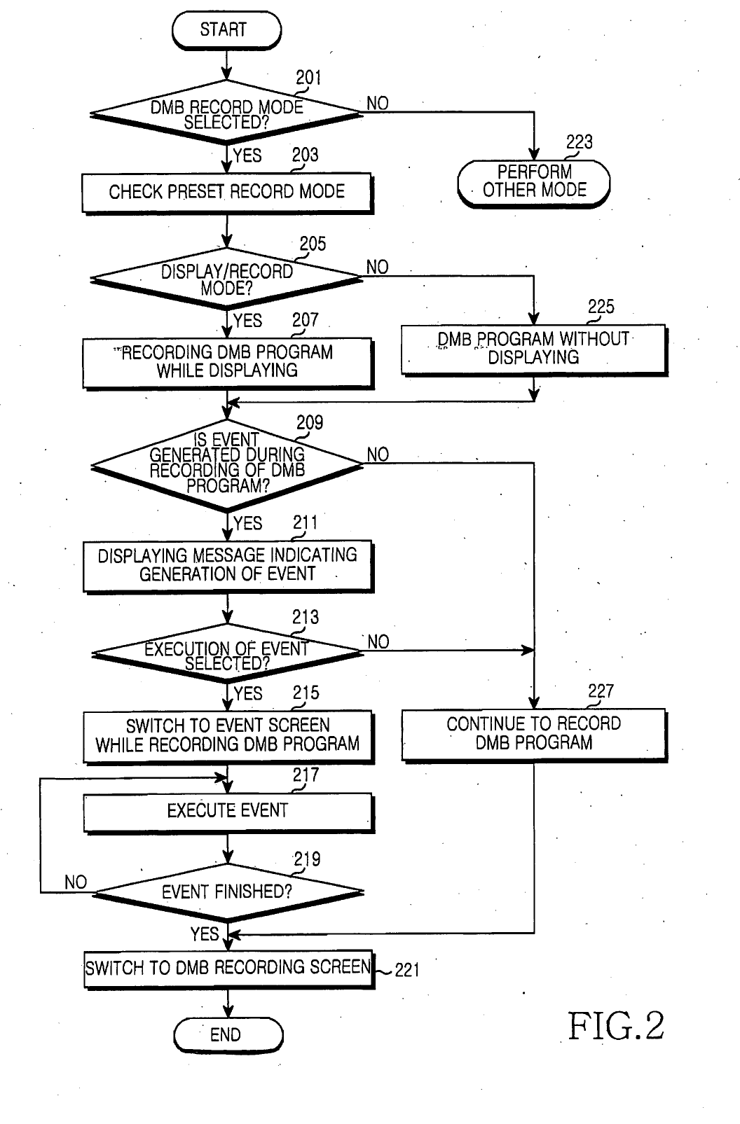

Referring to FIG. 2, control unit 100 determines if a DMB record mode is selected by a user's key manipulation in step 201. When the DMB record mode is not selected, control unit 100 performs other modes (e.g., a standby mode) in step 223. When the DMB record mode is selected, control unit 100 checks a preset record mode in step 203 and determines if the preset record mode is a display/record mode of recording the program while displaying it in step 205.

When the preset record mode is not the display/record mode, control unit 100 records the DMB program without displaying it on display unit 104 of the mobile terminal in step 225. At this point, whether to display the DMB program while recording it can be changed by the user's key manipulation.

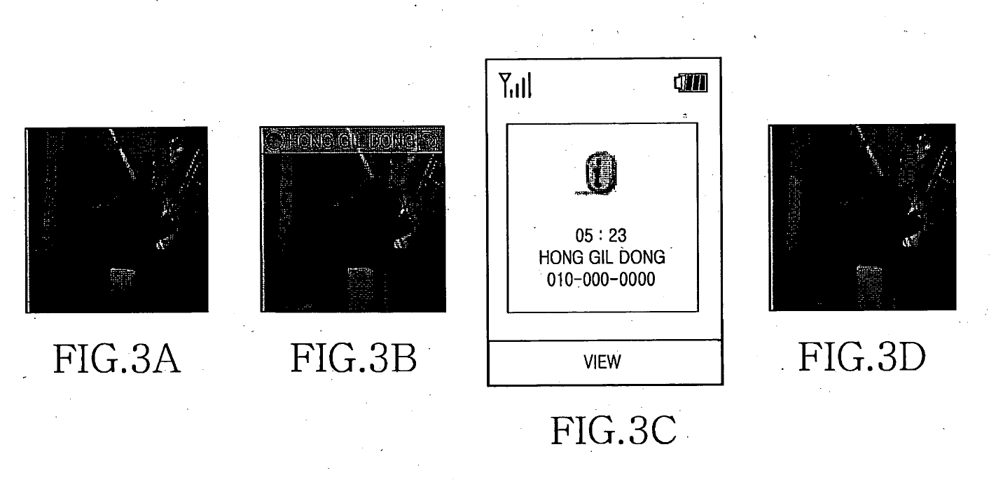

When the preset record mode is the display/record mode, control unit 100 records the DMB program while displaying it on display unit 104 of the mobile terminal in step 207. For example, as shown in FIG. 3A, when the mobile terminal receives the DMB signal and starts to record the DMB program, control unit 100 displays a text or icon indicating that the recording of the DMB program is in progress on an upper portion of display unit 104. At this point, the DMB program may or may not be displayed on display unit 104 according to the user's setting.

When the recording of the DMB program is in progress, control unit 100 determines if an event (e.g., call reception, message reception/transmission, alarm morning call, schedule notification, scheduled recording, etc.) is generated in step 209. When the event is not generated during the recording of the DMB program, control unit 100 continuously records the DMB program in step 227.

When the event is generated during the recording of the DMB program, control unit 100 displays a message indicating the generation of the event on display unit 104 in step 211. For example, as shown in FIG. 3B, when the call reception event is generated during the recording of the DMB program, control unit 100 displays a caller's name corresponding to a caller's phone number, and a message or icon indicating the call reception on the upper portion of display unit 104.

In step 213, control unit 100 determines if the execution of the event generated by the user's key manipulation is selected.

When the execution of the event is not selected, control unit 100 continuously records the DMB program in step 227.

In step 215, when the execution of the event is selected, control unit 100 switches to an event screen while recording the DMB program in the background. For example, as illustrated in FIG. 3C, control unit 100 displays the call reception event screen of FIG. 3B while recording the DMB program in the background, and processes the generated call reception event.

Control unit 100 executes the generated event in step 217, and determines if the event generated during the recording of the DMB program is finished in step 219. When the event is not finished, the process returns to step 217. In step 221, when the event is finished, control unit 100 switches to the previous screen, that is, the screen being displayed before the event is generated. For example, as shown in FIG. 3D, control unit 100 switches to the previous screen and displays the DMB program that is being recorded. Thereafter, control unit 100 terminates the process.

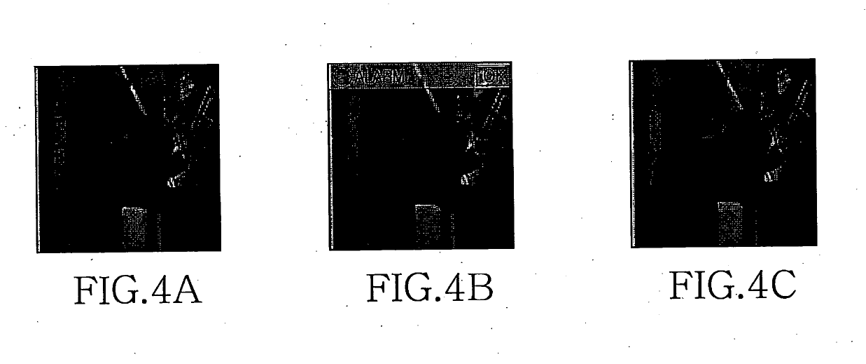

Although the processing of the call reception event generated during the recording of the DMB program has been described, the present invention can also be applied to the generation of the alarm event as shown in FIGS. 4A to 4C.

As shown in FIG. 4A, when the mobile terminal receives the DMB signal and starts to record the DMB program, control unit 100 displays a text or icon indicating that the recording of the DMB program is in progress on an upper portion of display unit 104.

As shown in FIG. 4B, when the alarm event generated during the recording of the DMB program, an alarm message or icon and an OK button for disabling the alarm function are displayed on an upper portion of display unit 104.

As shown in FIG. 4C, when the alarm event is finished, control unit 100 switches to the previous screen, that is, the screen being displayed before the alarm event is generated.

The method for processing the call reception event and the alarm event generated during the recording of the DMB program in the DMB mobile terminal has been described.

Furthermore, the present invention can also be applied to other events such as the morning call, the schedule notification, and message reception, which are generated during the recording of the DMB program.

The events can be generated during the displaying of the DMB program as well as during the recording of the DMB program.

As described above, the present invention provides the multi-tasking method for the DMB mobile terminal, and more particularly for processing the event generated during the recording of the DMB program, which can support the multi-tasking function when the events such as message reception, alarm, and call reception are generated during the recording of the incoming DMB program.

Alternate embodiments of the present invention can also comprise computer readable codes on a computer readable medium. The computer readable medium includes any data storage device that can store data that can be read by a computer system. Examples of a computer readable medium include magnetic storage media (such as ROM, floppy disks, and hard disks, among others), optical recording media (such as CD-ROMs or DVDs), and storage mechanisms such as carrier waves (such as transmission through the Internet). The computer readable medium can also be distributed over network coupled computer systems so that the computer readable code is stored and executed in a distributed fashion. Also, functional programs, codes, and code segments for accomplishing the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A method for processing an event generated during a recording of a DMB program in a DMB mobile terminal, comprising the steps of:
recording an incoming DMB program when a DMB record mode is selected;
determining if an event is generated during the recording of the DMB program;
determining whether to execute the generated event; and
processing the generated event while recording the DMB program when the execution of the generated event is selected.

2. The method of claim 1, further comprising notifying the generation of the event using an icon or message when the event is generated during the recording of the DMB program.

3. The method of claim 1, wherein the event is one of a call reception, a message reception/transmission, an alarm, a morning call, a schedule notification, and a scheduled recording.

4. The method of claim 1, wherein the DMB program is displayed or not during the recording of the DMB program according to a preset record mode.

5. The method of claim 1, further comprising switching to a DMB recording screen when the execution of the generated event is finished.

6. The method of claim 1, wherein the step of processing the generated event comprises switching to an event screen while recording the DMB program.

7. The method of claim 6, further comprising displaying an indicator notifying that the recording of the DMB program is in progress on the even screen.

8. The method of claim 1, wherein the step of processing the generated event comprises:
popping up the event screen on a screen where the DMB program being recorded is displayed; and
processing the generated event.

9. A method for executing an event generated during a recording of a broadcasting program in a mobile communication terminal having a broadcasting module, comprising the steps of:
identifying an event generated during recording of a broadcasting program;
selecting to execute the event; and
executing the event during the recording the broadcasting program when the execution of the event is selected.

10. The method of claim 9, wherein the event is one of a call reception, a message reception/transmission, an alarm, a morning call, a schedule notification, and a scheduled recording.

11. A mobile communication terminal having a broadcasting module, comprising:
a controller for identifying an event generated during recording of a broadcasting program and executing the event during the recording the broadcasting program when the execution of the event is selected; and
an input means for selecting to execute the event.

12. The mobile communication terminal of claim 11, wherein the controller further performs notifying the generation of the event using an icon or message when the event is generated during the recording of the program.

13. The mobile communication terminal of claim 11, wherein the event is one of a call reception, a message reception/transmission, an alarm, a morning call, a schedule notification, and a scheduled recording.

14. The mobile communication terminal of claim 11, wherein the program is displayed or not during the recording of the program according to a preset record mode.

15. The mobile communication terminal of claim 11, wherein the controller further performs switching to a recording screen when the execution of the generated event is finished.

16. The mobile communication terminal of claim 11, wherein the step of executing the event comprises switching to an event screen while recording the program.

17. The mobile communication terminal of claim 16, wherein the controller further performs displaying an indicator notifying that the recording of the program is in progress on the even screen.

18. The method of claim 1, wherein the step of executing the event comprises popping up the event screen on a screen where the DMB program being recorded is displayed and processing the generated event.

19. A computer-readable recording medium having recorded thereon a program for executing an event generated during a recording of a broadcasting program in a mobile communication terminal having a broadcasting module, comprising:
a first code segment for identifying an event generated during recording of a broadcasting program;
a second code segment for selecting to execute the event; and
a third code segment for executing the event during the recording the broadcasting program when the execution of the event is selected.

20. A computer-readable recording medium having recorded thereon a program for processing an event generated during a recording of a DMB program in a DMB mobile terminal, comprising:
a first segment for recording an incoming DMB program when a DMB record mode is selected;
a second segment for determining if an event is generated during the recording of the DMB program;
a third segment for determining whether to execute the generated event; and
a fourth segment for processing the generated event while recording the DMB program when the execution of the generated event is selected.
